(19) United States
(12) Patent Application Publication
(10) Pub. No.: US 2026/0128413 A1
(43) Pub. Date: May 7, 2026

(54) TRACTION BATTERY PACK IMMERSION THERMAL MANAGEMENT SYSTEM WITH A PLURALITY OF INLET APERTURES TO AN INTERIOR OF AN ENCLOSURE ASSEMBLY

(71) Applicant: Ford Global Technologies, LLC, Dearborn, MI (US)

(72) Inventors: Wen Dai, Northville, MI (US); Jianwen Yi, West Bloomfield, MI (US); Xiaogang Zhang, Novi, MI (US)

(21) Appl. No.: 18/935,999

(22) Filed: Nov. 4, 2024

(51) Int. Cl. H01M 10/6568; B60L 50/64; H01M 10/613; H01M 10/625; H01M 10/643; H01M 50/213; H01M 50/249; H01M 50/358; H01M 50/367

(52) U.S. Cl. CPC H01M 10/6568; B60L 50/64; H01M 10/613; H01M 10/625; H01M 10/643; H01M 50/213; H01M 50/249; H01M 50/358; H01M 50/367; H01M 2220/20

(57) ABSTRACT

A traction battery pack immersion thermal management system includes a coolant delivery system that communicates a coolant from a coolant supply to an enclosure assembly that houses a plurality of battery cells. The coolant delivery system includes a plurality of inlet apertures to the enclosure assembly. A coolant return system communicates the coolant from the enclosure assembly back to the coolant supply. The coolant return system including at least one outlet aperture from the enclosure assembly.

### TECHNICAL FIELD

This disclosure details exemplary immersion thermal management systems having more than one inlet to a battery pack enclosure assembly.

### BACKGROUND

Electrified vehicles differ from conventional motor vehicles because electrified vehicles include a drivetrain having one or more electric machines. The electric machines can drive the electrified vehicles instead of, or in addition to, an internal combustion engine. A traction battery pack assembly can power the electric machines. As part of an immersion thermal management system, coolant can be moved through the traction battery pack to help manage thermal energy within the traction battery pack.

### SUMMARY

In some aspects, the techniques described herein relate to a traction battery pack immersion thermal management system, including: a coolant delivery system that communicates a coolant from a coolant supply to an enclosure assembly that houses a plurality of battery cells, the coolant delivery system including a plurality of inlet apertures to the enclosure assembly; and a coolant return system that communicates the coolant from the enclosure assembly back to the coolant supply, the coolant return system including at least one outlet aperture from the enclosure assembly.

In some aspects, the techniques described herein relate to an immersion thermal management system, wherein the plurality of battery cells are a plurality of cylindrical battery cells.

In some aspects, the techniques described herein relate to an immersion thermal management system, wherein the plurality of battery cells each vent through a floor of the enclosure assembly.

In some aspects, the techniques described herein relate to an immersion thermal management system, wherein the plurality of battery cells are a plurality of cylindrical battery cells.

In some aspects, the techniques described herein relate to an immersion thermal management system, wherein the plurality of inlet apertures are vertically higher than the at least one outlet aperture.

In some aspects, the techniques described herein relate to an immersion thermal management system, wherein the plurality of battery cells are configured to vent into a venting chamber.

In some aspects, the techniques described herein relate to an immersion thermal management system, wherein the venting chamber is vertically beneath the plurality of battery cells.

In some aspects, the techniques described herein relate to an immersion thermal management system, wherein the plurality of inlet apertures are a plurality of slots that open through a side of the enclosure assembly, the plurality of slots each having a slot height, wherein the plurality of battery cells each have a battery cell height that is less than the slot height of each of the slots within the plurality of slots.

In some aspects, the techniques described herein relate to an immersion thermal management system, wherein the plurality of inlet apertures are vertically higher than the at least one outlet aperture.

In some aspects, the techniques described herein relate to an immersion thermal management system, wherein no portion of the plurality of inlet apertures vertically overlaps with any portion of the at least one outlet aperture.

In some aspects, the techniques described herein relate to an immersion thermal management system, wherein the plurality of inlet apertures are a first distance from a floor of the enclosure assembly, and the at least one outlet aperture is a second distance from the floor of the enclosure assembly, the first distance greater than the second distance.

In some aspects, the techniques described herein relate to an immersion thermal management system, wherein the plurality of inlet apertures are provided by a plurality of perforations in an inlet manifold.

In some aspects, the techniques described herein relate to an immersion thermal management system, wherein the plurality of inlet apertures are disposed along an inlet aperture axis, wherein each of the battery cells within the plurality of battery cells is a cylindrical battery cell that extends longitudinally along a battery cell axis that is transverse to the inlet aperture axis.

In some aspects, the techniques described herein relate to an immersion thermal management system, wherein the enclosure assembly includes a tray and a cover.

In some aspects, the techniques described herein relate to an immersion thermal management system, wherein the plurality of inlet apertures are on a first horizontal side of the enclosure assembly, wherein the at least one outlet aperture is on an opposite, second horizontal side of the enclosure assembly.

In some aspects, the techniques described herein relate to an immersion thermal management system, further including a venting chamber adjacent the cells.

In some aspects, the techniques described herein relate to a method of managing thermal energy levels within a traction battery pack, including: delivering a coolant from a coolant supply to an enclosure assembly through a plurality of inlet apertures, the enclosure assembly housing a plurality of battery cells; and communicating the coolant from the enclosure assembly through at least one outlet aperture.

In some aspects, the techniques described herein relate to a method, wherein the plurality of inlet apertures are each vertically misaligned with the at least one outlet.

In some aspects, the techniques described herein relate to a method, wherein the plurality of battery cells are cylindrical battery cells.

In some aspects, the techniques described herein relate to a method, further including arranging the plurality of battery cells to vent downward into a venting chamber.

The embodiments, examples and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

### BRIEF DESCRIPTION OF THE FIGURES

The various features and advantages of the disclosed examples will become apparent to those skilled in the art from the detailed description. The figures that accompany the detailed description can be briefly described as follows:

FIG. 1 illustrates a side view of an electrified vehicle having a battery pack.

FIG. 2 illustrates a highly schematic view of the battery pack from FIG. 1 along with a schematic view of an associated immersion thermal management system according to an exemplary aspect of the present disclosure.

FIG. 3 illustrates a section view taken at line 3-3 in FIG. 2.

FIG. 4 illustrates a battery cell from the battery pack of FIG. 2.

FIG. 5 illustrates a partially expanded view of the battery pack of FIG. 2.

FIG. 6 illustrates a side view of an inlet manifold of the battery pack of FIG. 2.

FIG. 7 illustrates a section view taken at line 7-7 in FIG. 2.

FIG. 8 illustrates a side view of an outlet manifold of the battery pack of FIG. 2.

### DETAILED DESCRIPTION

An immersion thermal management system can be used to manage thermal energy in a traction battery pack, which can include a plurality of battery cells and other components held within an enclosure assembly. The components within the enclosure are immersed in a fluid such as a liquid coolant. The immersed components can include battery cells. The liquid coolant can be used to manage thermal energy in the battery cells and in other components. The coolant can be used to cool the battery cells. In some examples, the coolant can be used to heat the battery cells.

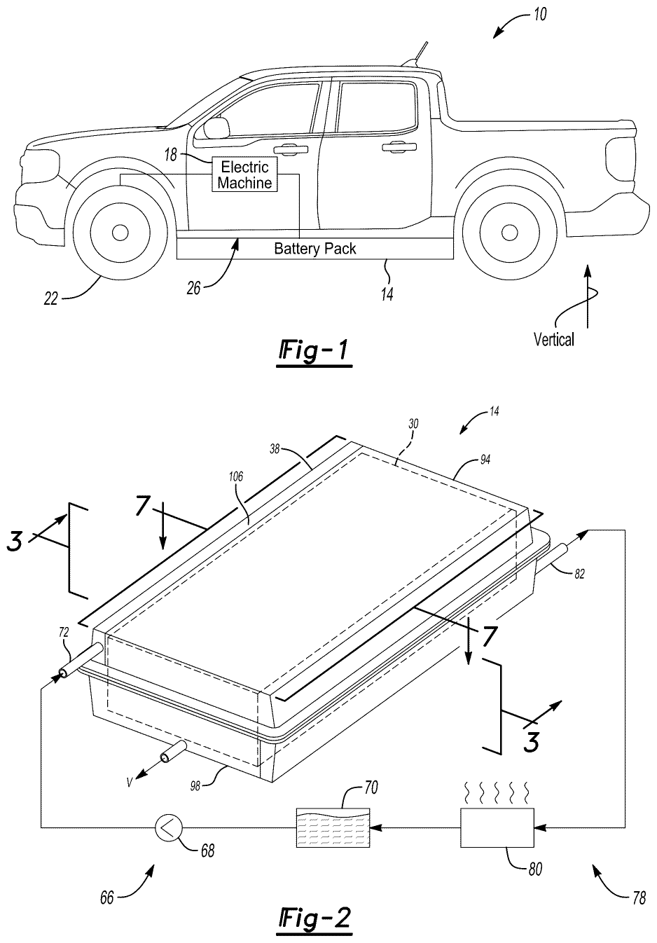

With reference to FIG. 1, an electrified vehicle 10 includes a battery pack 14, an electric machine 18, and wheels 22. The battery pack 14 powers the electric machine 18, which can convert electrical power to mechanical power to drive the wheels 22. The battery pack 14 is thus a traction battery pack.

The battery pack 14 is, in the exemplary embodiment, secured to an underbody 26 of the electrified vehicle 10. The battery pack 14 could be located elsewhere on the electrified vehicle 10 in other examples.

The electrified vehicle 10 is an all-electric vehicle. In other examples, the electrified vehicle 10 is a hybrid electric vehicle, which selectively drives wheels using torque provided by an internal combustion engine instead of, or in addition to, an electric machine. Generally, the electrified vehicle 10 could be any type of vehicle having a traction battery pack.

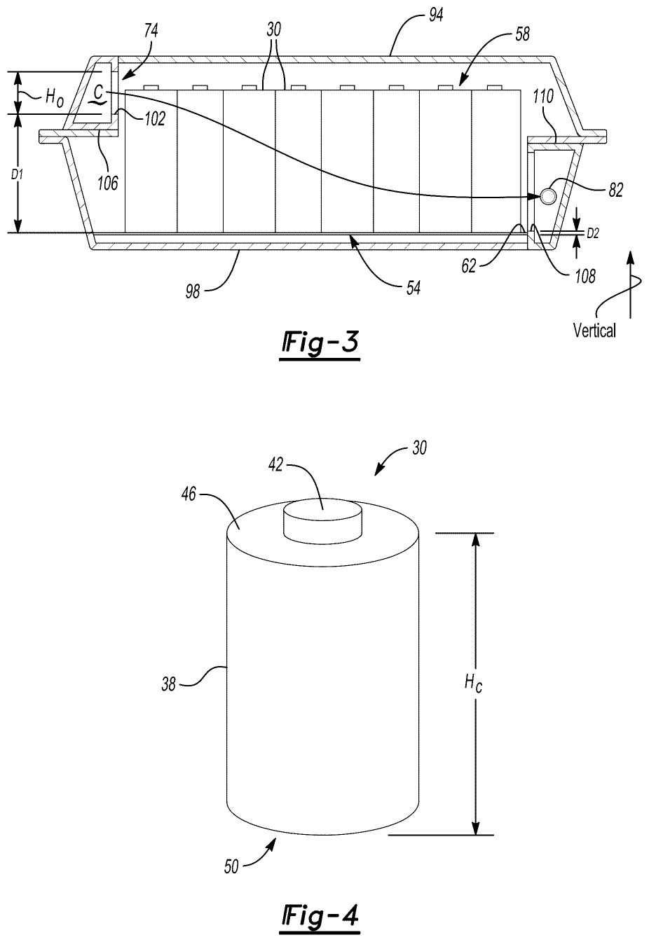

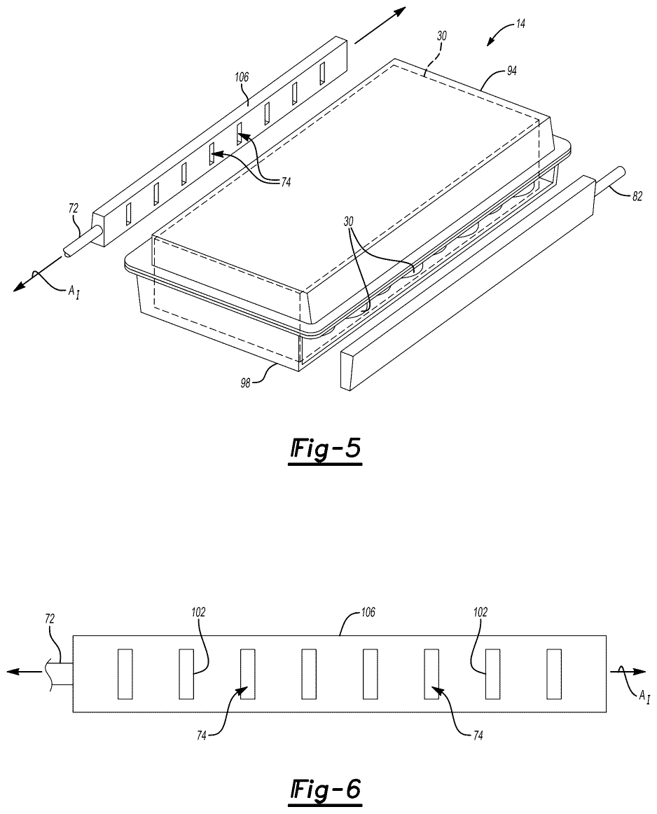

With reference now to FIGS. 2-5, an example immersion thermal management system is utilized to manage thermal energy levels within the battery pack 14. In the exemplary embodiment, the system is utilized to cool components of the battery pack 14. In other examples, the system instead or additionally heats components of the battery system.

In this example, the battery pack 14 includes a plurality of individual battery cells 30 held within an enclosure assembly 34. The group of the battery cells 30 are represented by broken lines in FIG. 2.

The example battery cells 30 are cylindrical battery cells having a jellyroll-style electrode structure housed within an outer casing 38. A cap 42 of the outer casing 38 provides a positive terminal at a first axial end of the cylindrical cell 30. A ring 46 of the casing 38 provides a negative terminal at the first axial end of the cell 30.

During a thermal event, the cells 30 are configured to vent through a side 50 at an opposite second axial end of the cells 30. In this example, the cells 30 are arranged such that the cells 30 vent into a vent chamber 54, which is adjacent to the battery cells 30 and, in this example, vertically beneath the cells 30. Vertical, for purposes of this disclosure, is with reference to ground in a general orientation of the battery pack 14 when utilized within the vehicle 10.

Although the cells 30 are disclosed as cylindrical cells, other types of cells could be used in other examples. For example cells having other geometries (lithium-ion pouch-style, etc.), other chemistries (nickel-metal hydride, lead-acid, etc.), or both could alternatively be utilized within the scope of this disclosure.

The cells 30 are housed within an interior 58 provided by the enclosure assembly 34. The vent chamber 54 is compartmentalized within the interior 58 by a floor 62.

The immersion thermal management system includes a coolant delivery system 66 that uses a pump 68 to communicate coolant C from a coolant supply 70 through an inlet port 72. The coolant C is then introduced through a plurality of inlet apertures 74 into the interior 58 of the enclosure assembly 34. Notably, the plurality of inlet apertures 74 are configured to each communicate coolant C into a singular interior area, not separate, compartmentalized areas within the interior 58. Eight inlet apertures 74 are used in the exemplary embodiment. Other examples could utilize other numbers of inlet apertures 74.

Within the interior 58, the cells 30 are immersed within the coolant C such that the coolant can take on thermal energy from the cells 30 and surrounding components of the battery pack 14. The coolant C can be a liquid, non-conductive (i.e., dielectric) coolant C. The thermal management system is considered an immersion thermal management system at least because portions of the battery pack 14, here at least the battery cells 30, are immersed in the coolant C.

The immersion thermal management system includes a coolant return system 78 that communicates coolant C from the enclosure assembly 34 back to the coolant supply. The coolant return system 78 includes, among other things, at least one outlet port 82 from the battery pack 14. Coolant from the outlet port 82 can flow to a thermal management assembly, such as a heat exchanger 80. At the heat exchanger 80, thermal energy can be transferred from the coolant C. The coolant C can then move from heat exchanger 80 to the coolant supply 70. The pump 68 can then draw coolant from the coolant supply 70 for circulation back through the battery pack 14.

Within the interior 58, the floor 62 blocks the coolant C from entering the venting chamber 54. Should one or more of the cells 30 vent, vent byproducts from the one or more cells 30 are discharged downward into the venting chamber 54, and then expelled from the venting chamber 54 and the battery pack 14 through a vent 90.

In the exemplary embodiment, the enclosure assembly 34 includes an enclosure cover 94 secured to an enclosure tray 98. The cover 94 can be secured to the tray 98 utilizing welds, for example. While welding is mentioned the cover 94 and the tray 98 could be secured to each other using other fluid-tight connection techniques, such as adhesive. The enclosure assembly 34 is shown and an example. The enclosure assembly 34 can vary in size, shape and configuration within the scope of this disclosure.

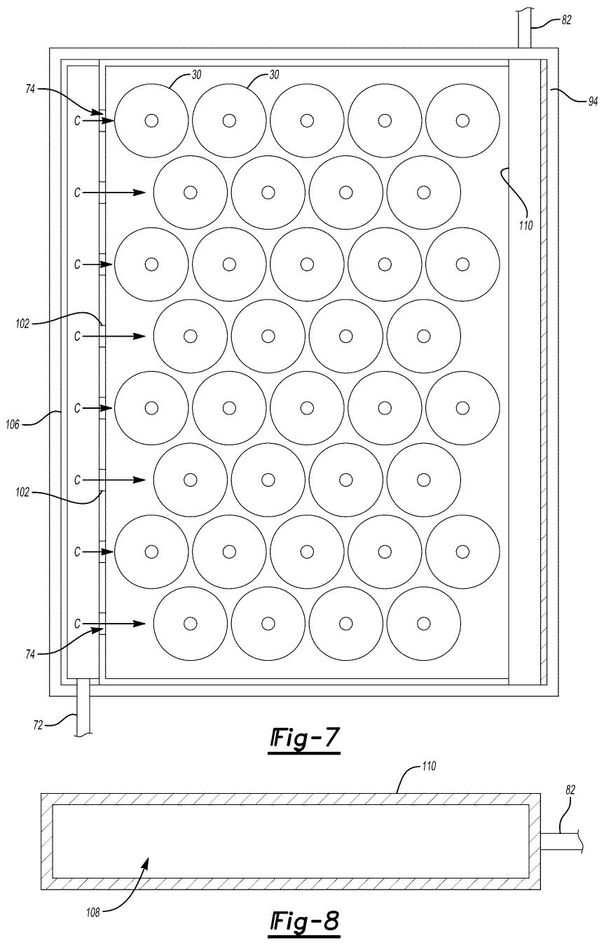

With reference now to FIGS. 6-8, and continuing reference to FIGS. 2-5, the inlet apertures 74 of the coolant delivery system 66 are, in the exemplary embodiment, provided by a plurality of slots 102 in an inlet manifold 106. The slots 102 are each positioned a distance D1 vertically above the floor 62. The slots 102 are disposed along an inlet slot axis A_{I}, which extends horizontally. The slots 102 each open to the interior 58. The slots 102 are staggered along the inlet slot axis A_{I}.

The battery cells 30 each extend along a longitudinal axis. The battery cells 30 are disposed on the floor 62 such that their longitudinal axes extend vertically. The longitudinal axes of the battery cells 30 are thus oriented transversely to the inlet slot axis A_{I}.

Coolant is communicated from the inlet manifold 106 to the interior 58 through the slots 102 at a plurality of horizontal locations along a side of the cells 30.

This example shows the slots 102 as having oval-shaped profiles. In some examples, the slots 102 are narrow slits, and can be considered perforations in the inlet manifold 106.

Introducing the coolant C to the interior 58 at a plurality of locations along the axis A_{I} can reduce a temperature gradient between the cells 30 of the battery pack 14 while keeping a flow rate of a coolant through the battery pack 14 substantially the same. In some examples, cell temperature gradients between the various cells have found to be within 4 degrees Celsius when compared to immersion systems introducing coolant C to an interior through a single inlet.

From the slots 102, the coolant C can move through the interior 58 over the battery cells 30 and through an outlet aperture 108 into an outlet manifold 110. The outlet aperture 108 has a rectangular profile and spans along the battery cells 30 along a length of the battery pack 14. One outlet aperture 108 is used in this example. In other examples, more than one outlet aperture 108 could be utilized. From the outlet manifold 110, the coolant C moves through the outlet port 82.

In this example, the outlet aperture 108 is spaced a distance D2 from the floor 62. The distance D2 is less than the distance D1. Coolant C moves vertically downward when moving through the interior 58 from the inlet apertures 74 to the outlet aperture 108. The outlet aperture 108 is disposed vertically below each of the inlet apertures 74 such that the outlet aperture 108 and the inlet apertures 74 are vertically misaligned. That is, the plurality of inlet apertures 74 are vertically higher than the outlet aperture 108. Further, in the exemplary embodiment, no portion of the plurality of inlet apertures 74 vertically overlaps with any portion of the outlet aperture 108.

In this example, the inlet apertures 74 having a height Hₒ that is less than a height H_{C} of the battery cells 30. In other examples, the inlet apertures 74 taller than the battery cells 30. That is, the inlet apertures 74 could extend vertically upward from the floor 62 past the battery cells 30. Such inlet apertures 74 would have a height that is greater than a height H of the battery cells 30.

In the exemplary embodiment of FIGS. 2-8, the inlet apertures 74 are elevated relative to the outlet aperture 108. In other examples, the inlet apertures 74 and the outlet aperture 108 could be vertically aligned.

The preceding description is exemplary rather than limiting in nature. Variations and modifications to the disclosed examples may become apparent to those skilled in the art that do not necessarily depart from the essence of this disclosure. Thus, the scope of protection given to this disclosure can only be determined by studying the following claims.

What is claimed is:

1. A traction battery pack immersion thermal management system, comprising:
a coolant delivery system that communicates a coolant from a coolant supply to an enclosure assembly that houses a plurality of battery cells, the coolant delivery system including a plurality of inlet apertures to the enclosure assembly; and
a coolant return system that communicates the coolant from the enclosure assembly back to the coolant supply, the coolant return system including at least one outlet aperture from the enclosure assembly.

2. The immersion thermal management system of claim 1, wherein the plurality of battery cells are a plurality of cylindrical battery cells.

3. The immersion thermal management system of claim 1, wherein the plurality of battery cells each vent through a floor of the enclosure assembly.

4. The immersion thermal management system of claim 3, wherein the plurality of battery cells are a plurality of cylindrical battery cells.

5. The immersion thermal management system of claim 4, wherein the plurality of inlet apertures are vertically higher than the at least one outlet aperture.

6. The immersion thermal management system of claim 2, wherein the plurality of battery cells are configured to vent into a venting chamber.

7. The immersion thermal management system of claim 6, wherein the venting chamber is vertically beneath the plurality of battery cells.

8. The immersion thermal management system of claim 1, wherein the plurality of inlet apertures are a plurality of slots that open through a side of the enclosure assembly, the plurality of slots each having a slot height, wherein the plurality of battery cells each have a battery cell height that is less than the slot height of each of the slots within the plurality of slots.

9. The immersion thermal management system of claim 1, wherein the plurality of inlet apertures are vertically higher than the at least one outlet aperture.

10. The immersion thermal management system of claim 9, wherein no portion of the plurality of inlet apertures vertically overlaps with any portion of the at least one outlet aperture.

11. The immersion thermal management system of claim 1, wherein the plurality of inlet apertures are a first distance from a floor of the enclosure assembly, and the at least one outlet aperture is a second distance from the floor of the enclosure assembly, the first distance greater than the second distance.

12. The immersion thermal management system of claim 1, wherein the plurality of inlet apertures are provided by a plurality of perforations in an inlet manifold.

13. The immersion thermal management system of claim 1, wherein the plurality of inlet apertures are disposed along an inlet aperture axis, wherein each of the battery cells within the plurality of battery cells is a cylindrical battery cell that extends longitudinally along a battery cell axis that is transverse to the inlet aperture axis.

14. The immersion thermal management system of claim 1, wherein the enclosure assembly includes a tray and a cover.

15. The immersion thermal management system of claim 1, wherein the plurality of inlet apertures are on a first horizontal side of the enclosure assembly, wherein the at least one outlet aperture is on an opposite, second horizontal side of the enclosure assembly.

16. The immersion thermal management system of claim 1, further comprising a venting chamber adjacent the cells.

17. A method of managing thermal energy levels within a traction battery pack, comprising:
delivering a coolant from a coolant supply to an enclosure assembly through a plurality of inlet apertures, the enclosure assembly housing a plurality of battery cells; and
communicating the coolant from the enclosure assembly through at least one outlet aperture.

18. The method of claim 17, wherein the plurality of inlet apertures are each vertically misaligned with the at least one outlet.

19. The method of claim 17, wherein the plurality of battery cells are cylindrical battery cells.

20. The method of claim 17, further comprising arranging the plurality of battery cells to vent downward into a venting chamber.
